(19) United States
(12) Patent Application Publication
(10) Pub. No.: US 2003/0023713 A1
(43) Pub. Date: Jan. 30, 2003

(54) Monitoring appliance for data storage arrays, and a method of monitoring usage

(76) Inventors: Alastair Michael Slater, Malmesbury Wiltshire (GB); Mark Robert Watkins, Sneyd Park (GB); Andrew Michael Sparkes, Bishopston (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/185,724

(22) Filed: Jul. 1, 2002

(30) Foreign Application Priority Data
Jun. 30, 2001 (GB) 0116111.6

(51) Int. Cl. G06F 15/173; G06F 7/00; G06F 17/30

(52) U.S. Cl. 709/223; 707/10

(57) ABSTRACT

A monitoring appliance for a data storage array used by plural hosts to store data responds to stored metadata to interrogate the data storage array at intervals to establish the amount of usage of the data storage array. Each host can use the file system(s) and/or database(s) of its choice in portions of the data storage array allocated to it. The monitoring appliance has basic knowledge of all file systems/databases used by the hosts, and the metadata structure of those file systems/databases.

### BACKGROUND AND SUMMARY OF THE INVENTION

The invention relates to a monitoring appliance for data storage arrays of the kind used to store data for a number of independent end users or hosts, and to a method of monitoring the usage of such arrays.

It is known in the prior art for companies and other organisations with computer systems, known as hosts, to outsource the bulk storage of data from such systems to a storage service provider. These organisations obtain the benefit that they do not need to invest capital in large arrays of hard discs. The hosts may chose to manage the disc storage themselves, merely having the storage capacity provided by the service provider. However, the hosts may choose to have the storage capacity provided and managed by the service provider, which gives them the added benefit that they do not have to employ highly paid specialists to manage the data storage.

The storage service providers have large arrays of hard discs which provide capacity and logical disc devices to a plurality of hosts that utilise the arrays. Many hosts may utilise a shared disc resource or such a resource may be allocated to a single host, depending upon the requirements of the particular hosts. Each host is allocated a capacity of storage to exceed the expected requirements of a particular host. However, in the prior art the service provider generally has very limited or indeed no access to the data stored in the array by the hosts and hence very limited knowledge of the usage of the allocated capacity within the disc array, and thus a limited ability to monitor usage and to manage that resource properly.

One way in which this problem could be tackled in the prior art is to have dual mounts for file systems that reside on the disc arrays. That is the whole file system and the data contained within would be duplicated and read only in a second location for use by the service provider to monitor usage. However, in practice this approach has not been used, for a number of reasons. The first, and probably the most important, is that the service provider would have full access to the data stored by the hosts, which would in most cases be unacceptable to the hosts from a security point of view. The second is that this approach would require a great deal of maintenance overhead, both upon initial set-up and for on-going maintenance, thus being expensive to implement. Furthermore, for various reasons this option may not be technically possible in many situations. For example, the dual mount system may not be able to read the file systems housed in the disc array due to operating system incompatibilities.

It is an aim of the present invention to provide a new and improved monitoring appliance, and method of monitoring usage of data storage.

According to a first aspect of the present invention a monitoring appliance, for a data storage array that can be used by a number of hosts to store data, is configured to interrogate the data storage array from time to time to establish from metadata the amount of the data storage array that is used.

Each host may be using the file system(s) and/or database(s) of its choice in portions of the data storage array allocated to it. Preferably, the monitoring appliance has basic knowledge of all the file systems/databases used by the hosts.

Preferably the monitoring appliance has knowledge of the metadata structure of all the file systems and/or databases used by the hosts within the data storage array.

Conveniently the monitoring appliance posts reports on the usage of the data storage array by the hosts to a management station from time to time preferably at predetermined intervals or on demand. The reports on the usage of the data storage array may include detail on the level and manner of usage by each host of the portions of the data storage array allocated to them.

The monitoring appliance may comprise a stand alone computer connected to the data storage array via an input/output interconnect.

Conveniently the monitoring appliance is connected to the management station via a management interface.

A second aspect of the invention concerns a method of monitoring the usage of a data storage array used by a number of hosts to store data. Monitoring occurs without having access to the data thus stored. The method includes interrogating the data storage array to establish from metadata the initial level of usage. The data storage array is re-interrogated from time to time, preferably at intervals, to establish from metadata the current usage by the hosts on each occasion. Typically, the data on the usage by the hosts is posted, e.g., to a management station. Preferably, the interrogating and re-interrogating steps include establishing from the metadata which resources of the array are being used by the hosts. The resources are usually file systems and/or databases. A monitoring appliance, integral with or connected to the data, preferably performs the steps.

The re-interrogation of the data storage array may occur at regular intervals or on demand.

The metadata obtained from the data storage array conveniently includes data indicating the level and manner of usage of the data storage array by each of the hosts.

The data posted to the management station by the monitoring appliance preferably includes data indicating the level and manner of usage of the data storage array by each of the hosts.

### BRIEF DESCRIPTION OF THE DRAWINGS

An embodiment of a monitoring appliance for a data storage array in accordance with the invention will now be described with reference to the accompanying drawings, in which:

FIG. 1 is a schematic illustration of a prior art disc array and linked hosts;

FIG. 2 is a schematic illustration of a disc array linked to a monitoring appliance according a preferred embodiment of the invention;

FIG. 3 is a schematic illustration of a disc array incorporating a monitoring appliance according to a preferred embodiment of the invention, and

FIG. 4 is a flow chart of the operation of a preferred embodiment of the invention.

### DETAILED DESCRIPTION OF THE DRAWING

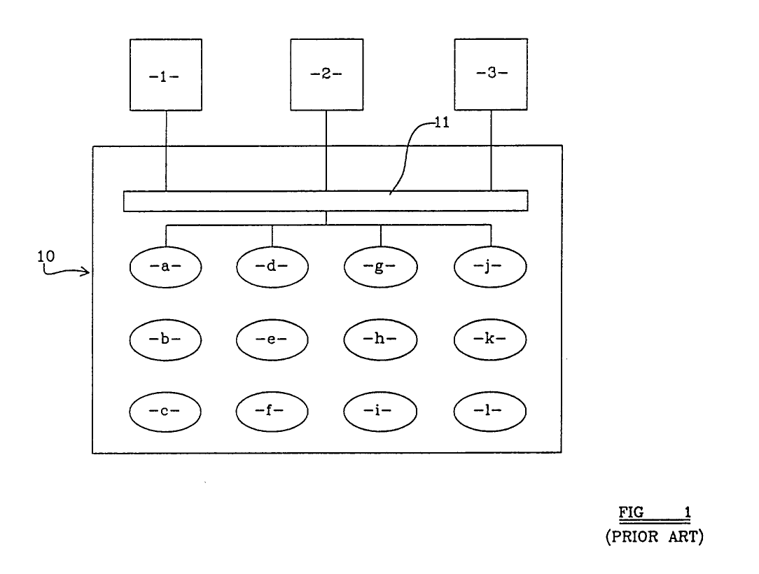

Referring first to FIG. 1, a prior art data storage array in the form of a disc array 10 is illustrated schematically. Hosts 1, 2 and 3 all use the disc array 10 for storage of their bulk data. Discs a to 1 of the disc array 10 are divided into a plurality of Logical Units (LUNs) which have physical locations on the discs a to 1. Each host has allocated to it part of a LUN, a LUN or a number of LUNs depending upon the expected maximum usage requirements of a particular host. Each host thus has allocated to it a physical area or a number of physical areas of the disc array 10. The physical area(s) of the disc array 10 allocated to a host is accessed by use of the relevant physical addresses, using an array controller 11.

Thus when data is written to, or read from, the array 10 by a host the array controller 11 performs a simple mapping operation for LUN sectors to read/write into physical addresses used within the array 10. A LUN may be considered as a continuous array of sectors numbered 0 to n−1 (where n determines the size of the LUN), which may be housed on a discontinuous set of disc devices.

However, the service provider has no knowledge of the operating systems being run by the hosts 1, 2 and 3, or the file systems which they are storing on the disc array 10 in their allocated LUNs. In addition, installation of the service provider's software on the hosts 1, 2, 3 for monitoring is also unpopular for security and policy reasons. Hence the service provider cannot monitor the hosts' usage of the allocated portions of the disc array 10 to any degree of accuracy, and thus cannot manage it as well as might otherwise be the case.

The prior art architecture can be summarised as:

disc array 6 LUNs 6 Hosts (application level access).

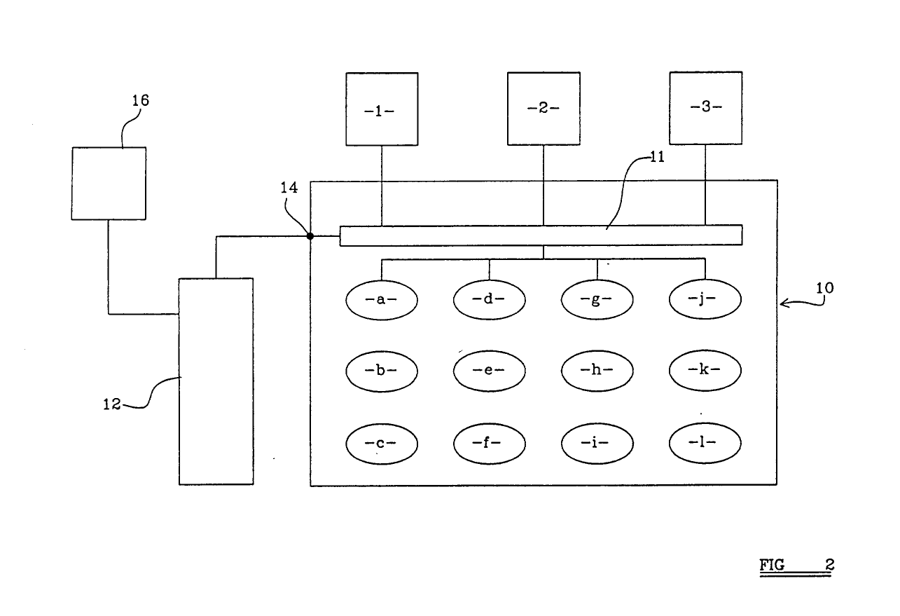

Referring now to FIG. 2, a disc array 10, which is the same as that in the prior art, is illustrated as linked to a monitoring appliance 12. The monitoring appliance 12 takes the form of a small computer running an embedded operating system, such as Linux, and performs only the monitoring function. The appliance 12 is connected to the disc array 10 via an I/O interconnect 14, e.g. fibre channel or SCSI, which may conveniently be the same one used by hosts to the disc array 10. The appliance 12 is however inaccessible to the hosts 1, 2 and 3 utilising the disc array 10. Inaccessibility is achieved by, for example, subnet masking to restrict access (as is known in the prior art).

The appliance 12 is also connected via a management interface, e.g. Ethernet, which may be internal to the appliance 12 or provided within the disc array 10, to a management station 16, to which reports on the usage of the disc array 10 may be posted.

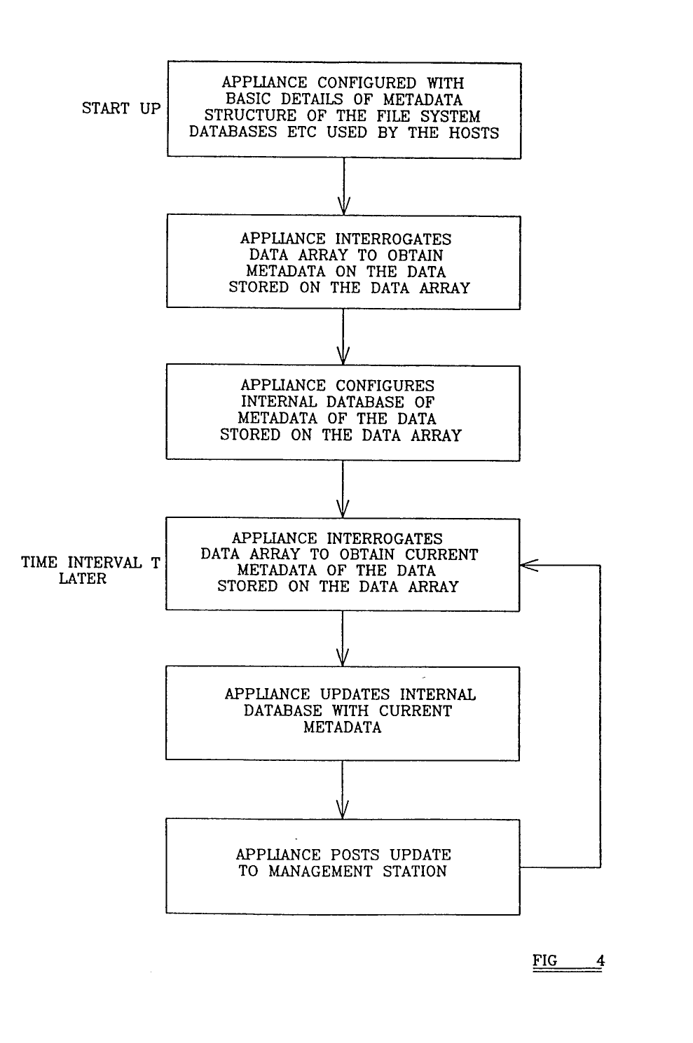

Assuming that there are file systems and/or databases on the disc array 10, the appliance 12 operates as follows, which is illustrated by the flow chart of FIG. 4.

The appliance 12 is provided with basic knowledge of the metadata structure of many different file systems and/or databases, such as could be used by the hosts, and at least all of the most commonly used ones. Examples of the kind of information contained within the metadata structure information are Fibre world name, target identifier, host operating system/usage type, i.e. sufficient to identify the target within the disc array and be able to access the metadata. The usage type may be file system, raw data or database. If the usage type is a file system, the particular base type is held (e.g. Solaris, VxFS, IRIX, UFS, HPUX, Windows FAT etc.).

Metadata is literally data about data. In this context, metadata means data about how the concerned file systems and/or databases concerned are organised and the data within them are formatted. Metadata can also include, more generally, information such as file creation times, file size, file access times, the location of files on a disc and about how, when, and by whom a particular set of data was collected. Metadata can be structured in many different ways, and thus for the appliance 12 to make use of metadata appliance 12 must be provided with the basic information as to how the metadata are structured for different file systems and software applications e.g. databases.

The appliance 12 interrogates the disc array 10, and without dual mounting the file systems and/or databases, determines the form of, structures of, and capacities of, the file systems/databases being stored on the host allocated areas of the disc array 10. Appliance 12 stores the metadata describing this information within a storage device in its operating environment.

By doing the interrogation, determining and storing steps, appliance 12 self configures an internal database of the host allocated areas of the disc array 10 and the related metadata of the file systems/databases and their initial levels of usage. The appliance 12 is software configured such that it cannot examine the data contained within the file systems/databases. The file system metadata are stored read-only in order, so as not to conflict with the host access of the file systems within the disc array 10. As such, the metadata are invisible from the host viewpoint and cannot interfere with the operation of the file systems/databases. Indeed the hosts have no visibility of the capacity monitoring appliance 12 at all.

After appliance 12 has stored the describing metadata, the appliance 12 re-interrogates disc array 10 from time to time preferably at regular time intervals T, e.g. every few minutes, to establish the then current usage of the file systems/databases by obtaining the current values of the metadata, which are added to the internal database of the appliance. Comparisons are then made between the original state of the file systems/databases and their state at any later time that the metadata is obtained.

In an alternative embodiment, the appliance 12 dual mounts the file systems and/or databases which are on the disc array 10. Appliance 12 only reads the file system and/or databases on array 10 in such a manner that the functioning of the data storage within the disc array 10 cannot generally be disrupted. At regular intervals thereafter appliance 12 compares the current state of the file systems and/or databases with the initial state thereof, by comparing the file systems and/or databases at the two times. This is performed by comparing the details of the file systems and/or databases at the two times. The two times are typically when dual mounting the metadata are not presented explicitly but can be derived from the mounted view of the data. This option does, however, have disadvantages. In some circumstances the fact that the file systems/databases are dual mounted affects the operation of the file systems and/or databases despite the fact that the file systems and/or databases are mounted in a read only state on the appliance 12. One of these circumstances is when file usage counts are in operation. Because the data are available to the service provider at the time, such is not acceptable to many hosts. In particular it would be difficult to restrict the access to the data within a dual mounted file system and/or databases.

With either manner of operation of the appliance 12, updates concerning the usage of the disc array 10 are posted to management station 16 via the management interface. The posting may conveniently use a simple kind of web publishing, such as an HTML web page, although any appropriate form that contains basic capacity usage information can be used. Appliance 12 posts such reports from time to time, e.g., at predetermined intervals, or as and when demanded by the management station.

If the application level access is of a database rather than a file system as such, with the host using a service which is raw disc capacity from the disc array 10, appliance 12 simply monitors raw disc capacity usage of the appropriate LUNs. If the host is using a database table then the capacity within that table must be monitored. To monitor capacity within a particular table, appliance 12 runs a cut down version of the database software run by the host, or an interface to such, e.g. Oracle ProC, to access the table space used by that host on the disc array 10. The metadata examined are appropriate for the application context and for databases that will concern database configuration and table spaces.

The appliance 12 automatically detects the allocation of new LUNs and the associated LUN usage. However, if at any time when a new host is allocated a portion of the disc array 10 and, on initial interrogation the appliance 12 does not recognise the file systems or database being used by that host, the service provider provides the appliance with basic knowledge of further file systems or databases. If appliance 12 still cannot identify the file system or database, an administrator of the host may be asked for information.

The architecture of the operation can be summarised as:

| | | |
|---|---|---|
| <management> | 7disc array | 6LUNs6hosts (application level access) |

| | |
|---|---|
| station | 7[capacity monitoring appliance] |

The management station 16, the disc array 10 and the appliance 12 reside at the service provider, with all other entities to the right residing or being accessible to the hosts 1, 2 and 3 of the service. The monitoring appliance 12 provides information to the service provider on the utilisation of the disc array 10 at an application level access, e.g. how much capacity is left within the file systems housed on the disc array 10 by the hosts, or how much table space is left if it is a database with tables.

The system and method enable the service provider to monitor in detail the usage of the disc array by the various hosts, both in terms of capacity used and in terms of the manner and timing of that usage. This greater knowledge of the usage can be used in a large number of ways, both for the direct benefit of the hosts, and for the benefit of the service provider in assisting in providing an improved service. For example, one way in which the monitoring can be used directly to benefit the hosts is to provide more granular billing relating to actual usage over time rather than simply to the gross area of the disc array allocated to a host. With regard to the benefit to the service provider in providing an improved service, the results of the monitoring can be used for examples:

forecast future usage trends and thus plan upgrades more accurately both in terms of the capacity provided and the kind of storage provided,

schedule maintenance to minimise disruption to service provision,

optimise disc array performance by (re-)arranging the way certain data are stored within the array,

enable the service provider to provide hierarchical storage management (HSM), for example, storing older and/or less often accessed data on slower off-line storage and newer and/or more often accessed data on the highest performance storage, and

enable the service provider to provide nuanced storage where different types of storage are provided for different levels of payment.

It will however be appreciated that the monitoring of the usage of the disc array can be used for many purposes which have not been described here.

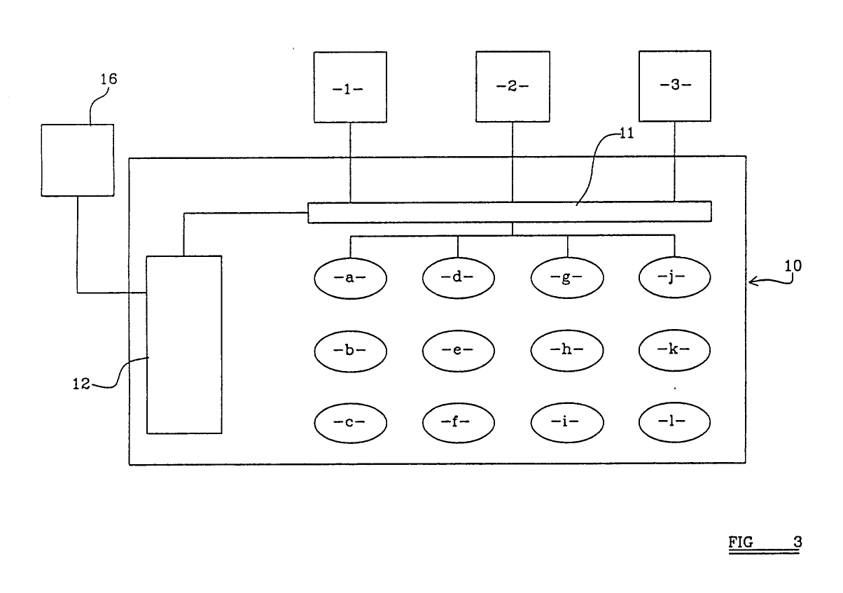

Although the monitoring appliance 12 is described as being linked to the disc array 10 it can conveniently be embedded within the disc array 10, as shown in FIG. 3 were like parts are like referenced.

The system is described above in conjunction with a disc array 10 comprising a plurality of hard discs. However, the system is equally applicable for use with other forms of data storage arrays employing alternative storage media, for examples: optical storage or solid-state storage such as magnetic RAM (MRAM).

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A monitoring appliance for a data storage array, the data storage array being adapted to be used by a number of hosts to store data, wherein the monitoring appliance is configured to interrogate the data storage array from time to time to establish from metadata the amount of usage of the data storage array.

2. A monitoring appliance according to claim 1 wherein each host is arranged to use at least one of the file system(s) and database(s) of its choice in portions of the data storage array allocated to them, and wherein the monitoring appliance has basic knowledge of all the file systems and databases used by the hosts.

3. A monitoring appliance according to claim 2 wherein the monitoring appliance has knowledge of the metadata structure of all the file systems and databases used by the hosts within the data storage array.

4. A monitoring appliance according to claim 2 wherein the monitoring appliance is arranged to post reports on the usage of the data storage array by the hosts to a management station at predetermined intervals or on demand.

5. A monitoring appliance according to claim 4 wherein the reports on the usage of the data storage array include detail on the level and manner of usage by each host of the portions of the data storage array allocated to them.

6. A monitoring appliance according to claim 4 wherein the monitoring appliance comprises a stand alone computer connected to the data storage array via an input/output interconnect.

7. A monitoring appliance according to claim 6 wherein the monitoring appliance is connected to the management station via a management interface.

8. A monitoring appliance according to claim 1 wherein the monitoring appliance is arranged to post reports on the usage of the data storage array by the hosts to a management station at predetermined intervals or on demand.

9. A monitoring appliance according to claim 1 wherein the monitoring appliance comprises a stand alone computer connected to the data storage array via an input/output interconnect.

10. A method of enabling monitoring the usage of a data storage array used by a number of hosts to store data, the monitoring being performed without having access to the data thus stored in the array, comprising the following steps:
(a) interrogating the data storage array to establish from metadata the initial level of usage, which file systems and/or databases are being used by the hosts, and of the array by the hosts;
(b) re-interrogating the data storage array from time to time to establish from metadata the amount of current usage of the array by the hosts on each occasion.

11. A method according to claim 10 further including posting data on the usage by the hosts to a management station.

12. A method according to claim 10, wherein the interrogating and re-interrogating steps include establishing from the metadata resources of the array being used by the hosts.

13. A method according to claim 12, wherein the resources include file systems.

14. A method according to claim 12, wherein the resources include databases.

15. A method according to claim 14, wherein the resources include file systems.

16. A method according to claim 12, wherein the steps are performed by a monitoring appliance, integral with or connected to the data storage array.

17. A method according to claim 11, wherein the steps are performed by a monitoring appliance, integral with or connected to the data storage array.

18. A method according to claim 10, wherein the steps are performed by a monitoring appliance, integral with or connected to the data storage array.

19. A method according to claim 10 wherein the re-interrogation of the data storage array occurs at regular intervals or on demand.

20. A method according to claim 10 wherein the metadata obtained from the data storage array includes data indicative of the level and manner of usage of the data storage array by each of the hosts.

21. A method according to claim 20 further including posting the data on the usage, the posted data including data indicating the level and manner of usage of the data storage array by each of the hosts.
